(19) United States
(12) Patent Application Publication
(10) Pub. No.: US 2015/0054262 A1
(43) Pub. Date: Feb. 26, 2015

(54) AIRBAG DEVICE FOR VEHICLE

(71) Applicant: HYUNDAI MOBIS CO., Ltd., Yongin-si (KR)

(72) Inventor: Oh Koang KWON, Yongin-si (KR)

(21) Appl. No.: 14/458,321

(22) Filed: Aug. 13, 2014

(30) Foreign Application Priority Data
Aug. 22, 2013 (KR) 10-2013-0099862

(51) Int. Cl. B60R 21/2338

(52) U.S. Cl. CPC B60R 21/2338; B60R 2021/0048
USPC 280/728.2

(57) ABSTRACT

An airbag device for a vehicle according to the present invention includes an inflator which generates high-pressure gas, and an airbag cushion which is expanded and deployed when high-pressure gas flows into the airbag cushion, and an external tether, which covers at least a part of an outer surface of the airbag cushion, is installed on the airbag cushion, thereby effectively protecting a passenger by preventing the opposite side of the airbag cushion from being lifted up when the head of the passenger comes into contact with a side of the airbag cushion at the time of a vehicle collision.

### CROSS-REFERENCE TO RELATED APPLICATIONS

The present application claims priority to Korean Patent Application Number 10-2013-0099862 filed Aug. 22, 2013, the entire contents of which the application is incorporated herein for all purposes by this reference.

### TECHNICAL FIELD

The present invention relates to an airbag device for a vehicle, and more particularly, to an airbag device for a vehicle capable of effectively protecting the head of a passenger by preventing the opposite side of an airbag cushion from being lifted up when the passenger comes into contact with a side of the airbag cushion.

### BACKGROUND

In general, various types of airbags are provided in a vehicle in order to protect a passenger seated in the vehicle at the time of a collision accident.

An airbag module may be classified by type into a driver airbag module (DAB) which is installed in a steering wheel of the vehicle so as to protect a driver, a passenger airbag module (PAB) which is installed in an instrument panel in front of a front passenger seat so as to protect a passenger seated on the front passenger seat, a seat airbag module (SAB) which is installed at each seat of the vehicle so as to protect a passenger from lateral impact, and a curtain airbag module (CAB) which is installed in a roof trim between a roof panel of inside a vehicle and a side door so as to protect a side of a passenger overall.

According to the airbag device for a vehicle in the related art, an airbag cushion is configured to be suitable for protecting a passenger, but there is a problem in that when the head of the passenger is positioned at a side of the airbag cushion at the time of a vehicle collision, the opposite side of the airbag cushion is lifted up, and as a result, an ability to absorb impact of the airbag cushion deteriorates.

### SUMMARY

The present invention has been made in an effort to provide an airbag device for a vehicle which may effectively protect a passenger even though the head of the passenger comes into contact with a side of the airbag cushion when an airbag cushion is deployed.

Technical problems of the present invention are not limited to the aforementioned technical problems, and other technical problems, which are not mentioned above, may be clearly understood by those skilled in the art from the following descriptions.

An exemplary embodiment of the present invention provides an airbag device for a vehicle, including: an inflator which generates high-pressure gas; an airbag cushion which is expanded and deployed when high-pressure gas flows into the airbag cushion from the inflator; and an external tether which is installed to cover at least a part of an outer surface of the airbag cushion and guides a deployment direction of the airbag cushion when the airbag cushion is expanded.

An internal tether, which restricts expansion in a forward direction of the airbag cushion when the airbag cushion is deployed, may be installed in the airbag cushion.

The airbag cushion may include a front panel which is positioned in a direction toward a passenger when the airbag cushion is deployed, and a rear panel which is positioned to face the front panel and has a mounting portion of the airbag cushion that is mounted in a housing of the airbag cushion, and the internal tether may have one end connected to the mounting portion of the airbag cushion, and the other end connected to the front panel.

The internal tether may include an upper internal tether and a lower internal tether that are spaced apart from each other in an upward and downward direction.

The external tether may cover an outer surface of the airbag cushion that is positioned at a height between the upper internal tether and the lower internal tether when the airbag cushion is deployed, and may be formed in a band shape having a predetermined vertical width.

The external tether may be positioned in an intermediate region between an upper portion and a lower portion when an airbag is deployed, and a fracture portion, which is fractured when the airbag cushion is deployed to a predetermined size, may be formed at the external tether.

The external tether may have a sewed portion which is joined to the front panel of the airbag cushion and torn when an airbag is deployed, the sewed portion may include first and second sewed portions that are spaced apart from a central portion of the front panel of the airbag cushion at a predetermined interval, and a portion of the external tether, which is positioned between the first and second sewed portions, may be separated from the remaining portion of the external tether when the sewed portion is torn.

The sewed portion may include third and fourth sewed portions that are spaced apart from the first and second sewed portions so as to face each other toward the rear panel of the airbag cushion, and the third and fourth sewed portions are sewed to be joined to the front panel more strongly than the first and second sewed portions so that the third and fourth sewed portions are torn after the first and second sewed portions are torn.

The external tether may be disposed to cover from a portion where the airbag cushion is mounted on the airbag housing, to a portion that is spaced apart at least toward a front side of the airbag cushion at a predetermined distance from a reference line where the airbag cushion has a maximum diameter when the airbag cushion is deployed.

Specific items of other exemplary embodiments are included in the detailed description and the drawings.

According to the airbag device for a vehicle of the present invention, there are one or more effects as follows.

Even though the head of the passenger comes into contact with a side of the airbag cushion at the time of a vehicle collision accident, the external tether is disposed, thereby effectively protecting the passenger by preventing the opposite side of the airbag cushion from being lifted up.

The airbag cushion and the external tether are coupled by the sewed portion, thereby preventing the external tether from being separated even by strong impact.

A weight of an airbag becomes light instead of increasing a volume of the airbag cushion, thereby easily manufacturing the airbag and reducing costs.

The effects of the present invention are not limited to the aforementioned effects, and other effects, which are not mentioned above, will be clearly understood by those skilled in the art from the claims.

### BRIEF DESCRIPTION OF THE DRAWINGS

FIG. 1 is a perspective view illustrating a state in which an airbag cushion of an airbag device for a vehicle according to the present invention is deployed.

FIG. 2 is a cross-sectional view taken along line A-A of FIG. 1.

FIG. 3 is a front view of FIG. 2.

FIG. 4 is a cross-sectional view illustrating another exemplary embodiment of the present invention.

FIG. 5 is a perspective view illustrating a state in which an airbag cushion for a vehicle in the related art is deployed.

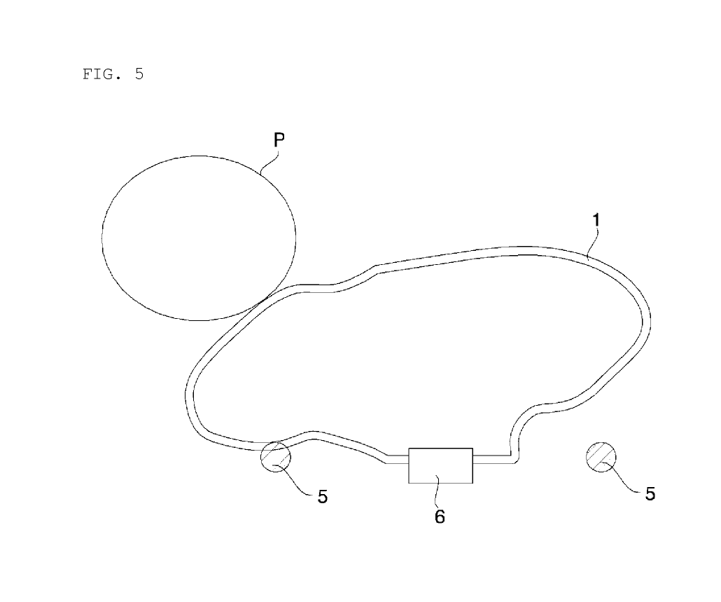

### DETAILED DESCRIPTION

Advantages and features of the present invention and methods of achieving the advantages and features will be clear with reference to exemplary embodiments described in detail below together with the accompanying drawings. However, the present invention is not limited to the exemplary embodiments set forth below, and may be embodied in various other forms. The present exemplary embodiments are for rendering the description of the present invention complete and are set forth to provide a complete understanding of the scope of the invention to a person with ordinary skill in the technical field to which the present invention pertains, and the present invention will only be defined by the scope of the claims. Like reference numerals indicate like elements throughout the specification.

Hereinafter, the present invention will be described with reference to the drawings for explaining an airbag device for a vehicle according to exemplary embodiments of the present invention.

The airbag device for a vehicle may be modified by those skilled in the corresponding technical field, and in the present exemplary embodiment, the airbag device for a vehicle will be described.

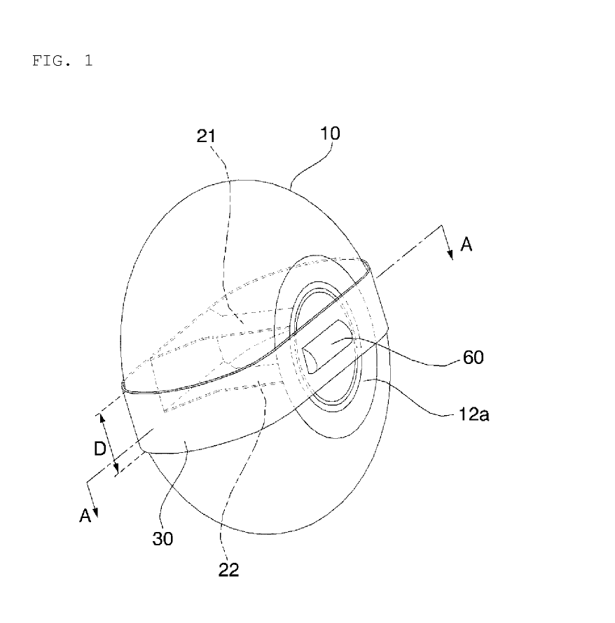

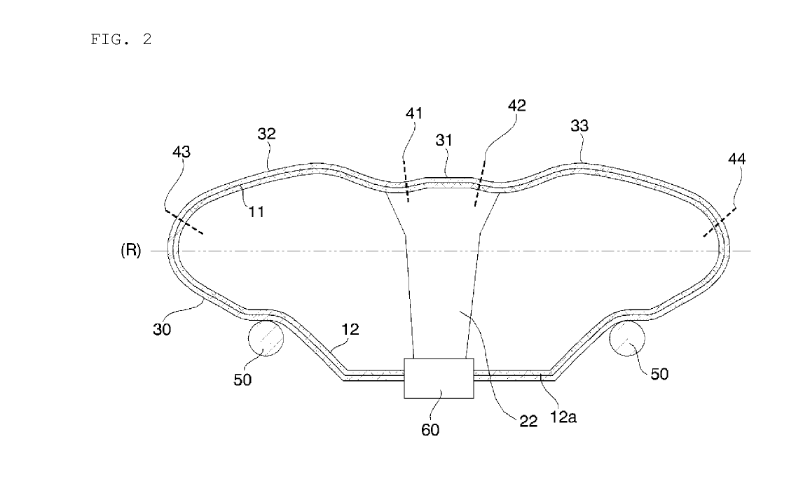

FIG. 1 is a perspective view illustrating an appearance in which an external tether included in a configuration of the airbag device for a vehicle according to the present invention is mounted, and FIG. 2 is a cross-sectional view taken along line A-A of FIG. 1.

Referring to FIGS. 1 and 2, the airbag device for a vehicle according to an exemplary embodiment of the present invention includes an inflator 60 which generates high-pressure gas, and an airbag cushion 10 which is expanded and deployed when high-pressure gas flows into the airbag cushion 10 from the inflator 60.

An external tether 30, which covers at least a part of an outer surface of the airbag cushion 10, is installed on the airbag cushion 10.

Internal tethers 21 and 22, which restrict the expansion in a forward direction of the airbag cushion 10 when the airbag cushion 10 is deployed, are installed in the airbag cushion 10.

The airbag cushion 10 includes a front panel 11 which is positioned in a direction toward a passenger when the airbag cushion 10 is deployed, and a rear panel 12 which is positioned to face the front panel 11 and has a mounting portion 12a mounted in a housing (not illustrated) of the airbag cushion, and the internal tethers 21 and 22 have one end connected to a mounting portion 12a of the airbag cushion, and the other end connected to a central portion of the front panel 11.

The internal tethers 21 and 22 include an upper internal tether 21 and a lower internal tether 22 that are spaced apart from each other at a predetermined interval D in an upward and downward direction, and the external tether 30 is installed to cover at least the outer surface of the airbag cushion 10, which is positioned in the interval D between the upper internal tether 21 and the lower internal tether 22, when the airbag cushion 10 is deployed.

The external tether 30 is formed in a band shape having a predetermined vertical width D, and positioned in an intermediate region between an upper portion and a lower portion when the airbag is deployed.

The external tether 30 is sewed and joined to the mounting portion 12a of the airbag cushion, and joined to the front panel 11 of the airbag cushion, and at least one portion of sewed portions 41 to 44 sewed on the front panel 11 of the airbag cushion is sewed so as to be torn when the airbag is deployed.

The sewed portion includes the first and second sewed portions 41 and 42 that are spaced apart from a central portion of the front panel 11 of the airbag cushion at a predetermined interval, respectively, and first and second fracture portions 51 and 52, which have a plurality of slits that is fractured when the sewed portions are torn, are formed between the first and second sewed portions 41 and 42.

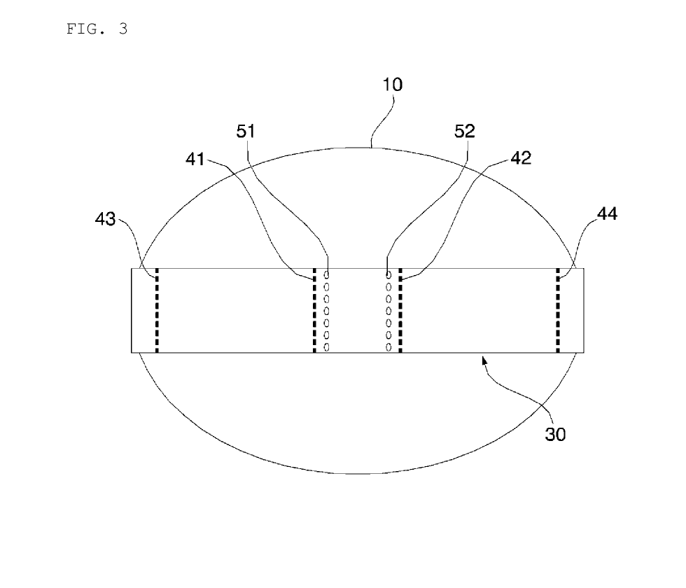

One fracture portion may be formed between the first and second sewed portions 41 and 42, and the fracture portions may be formed at positions adjacent to the first and second sewed portions 41 and 42, respectively, as illustrated in FIG. 3.

The sewed portions include third and fourth sewed portions 43 and 44 that are spaced apart from the first and second sewed portions 41 and 42 toward the rear panel 12 of the airbag cushion so as to face each other.

The third and fourth sewed portions 43 and 44 are sewed to be joined to the front panel 11 more strongly than the first and second sewed portions 41 and 42, respectively, such that the first and second sewed portions 41 and 42 are torn during the deployment of the airbag cushion 10, and the third and fourth sewed portions 43 and 44 maintain the sewed state thereof.

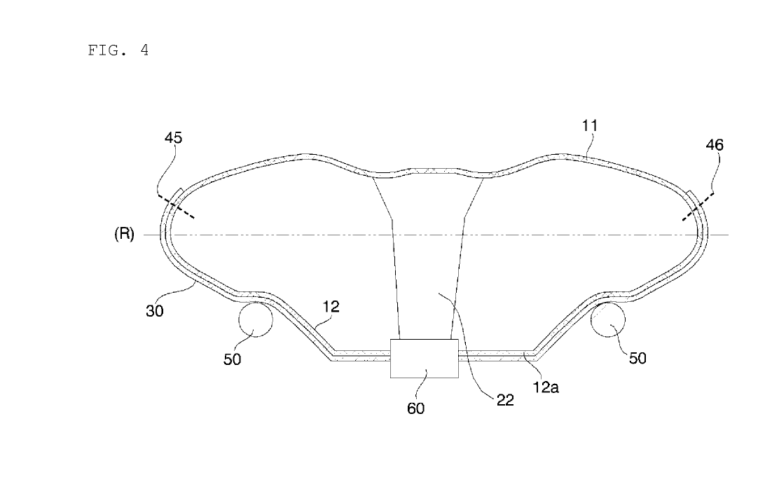

As illustrated in FIG. 4, the external tether 30 may be disposed to cover from the mounting portion 12a where the airbag cushion 10 is mounted on the airbag housing, to a portion that is spaced apart at least toward a front side of the airbag cushion 10 at a predetermined distance from a reference line R where the airbag cushion 10 has a maximum diameter when the airbag cushion 10 is deployed. That is, the external tether 30 may be disposed so as not to cover a part of the front panel 11 of the airbag cushion.

In this case, both ends of the external tether 30 are joined to the front panel 11 of the airbag cushion 10 by left and right sewed portions 45 and 46.

The airbag cushion 100 is folded several numbers of times and accommodated in an airbag housing (not illustrated), and the mounting portion 12a of the airbag cushion and the inflator 60 are fixed to the airbag housing.

An operation of the airbag device for a vehicle according to the present invention, which is configured as described above, will be described below. At the time of a vehicle collision, the internal tethers 21 and 22 are disposed in the airbag cushion 10 in a loosened state, and as the airbag cushion 10 is expanded, the internal tethers 21 and 22 are tightened to pull the front panel 11 so that the front panel 11 does not rapidly protrude toward the passenger, and restrict the expansion of the front panel 11.

The external tether 30 comes into close contact with at least a part of an outer surface of the airbag cushion 10, and guides the expansion direction of the airbag cushion 10.

The external tether 30 is disposed to prevent the opposite side of the airbag cushion 10 from being lifted up when the head P of the passenger comes into contact with a side of the airbag cushion 10 at the time of a vehicle collision, using a rigid member. In more detail, when the head P of the passenger comes into contact with a side of the airbag cushion 10, the external tether 30 guides the expansion direction of the airbag cushion 10 so as to prevent a portion of the airbag cushion 10, which faces the head of the passenger, from being lifted up.

The external tether 30 may be made of any material as long as the external tether 30 has higher rigidity than the airbag cushion, and may be formed of fabric having predetermined rigidity.

A part of the external tether 30 may come into contact with a steering wheel 50 when the airbag cushion 10 is expanded. Therefore, since the external tether 30 comes into contact with the steering wheel 50, the external tether 30 may serve as a support that prevents the airbag cushion 10 from being excessively expanded.

The external tether 30 is disposed to be vertical to a direction in which the internal tethers 21 and 22 are connected with the front panel 11, thereby preventing the airbag cushion 10 from being biased toward the left and right sides.

At the first and second sewed portions 41 and 42, the internal tethers 21 and 22 are disposed in the airbag cushion 10 in a loosened state, tightened as the airbag cushion 10 is expanded so as to pull the front panel 11 so that front panel 11 does not protrude toward the passenger, and torn when the airbag cushion 10 is expanded to a predetermined size or more, and the first and second fracture portions 51 and 52 are fractured, such that a portion of the external tether 30, which is positioned between the first and second sewed portions 41 and 42, does not restrict the expansion of the airbag cushion any further. Meanwhile, because a portion of the external tether 30, which is connected to the mounting portion 12a of the airbag cushion from the third and fourth sewed portions 43 and 44, has predetermined rigidity, the airbag cushion 10 is prevented from being lifted up toward the opposite side when the airbag cushion 10 is expanded, and the opposite side of the airbag cushion 10 is lifted up.

Meanwhile, in the exemplary embodiment of the present invention illustrated in FIG. 4, one side of the airbag cushion is prevented from being lifted up by the left and right sewed portions 45 and 46 and the external tether 30 positioned on the mounting portion 12a of the airbag cushion.

That is, in a case in which a vehicle collision is an offset collision instead of a head-on collision, a portion of the airbag cushion, which faces a portion that is in contact with the head P of the passenger, is lifted up, but in this case, the external tether 30 is tightened so as to prevent the airbag cushion 10 from being lifted up toward the opposite side, thereby effectively protecting the passenger.

The airbag device for a vehicle according to the exemplary embodiment is not applied to be limited by the aforementioned configuration and method of the exemplary embodiments, but the entirety or a part of the exemplary embodiments may be selectively combined so that various modifications of the exemplary embodiments may be made.

While the exemplary embodiment of the present invention has been illustrated and described above, the present invention is not limited to the aforementioned specific exemplary embodiment, various modifications may be made by a person with ordinary skill in the art to which the present invention pertains without departing from the subject matters of the present invention that are claimed in the claims, and these modifications should not be appreciated individually from the technical spirit or prospect of the present invention.

What is claimed is:

1. An airbag device for a vehicle, comprising:
an inflator which generates high-pressure gas;
an airbag cushion which is expanded and deployed when high-pressure gas flows into the airbag cushion from the inflator; and
an external tether which is installed to cover at least a part of an outer surface of the airbag cushion and guides a deployment direction of the airbag cushion when the airbag cushion is expanded.

2. The airbag device of claim 1, wherein an internal tether, which restricts expansion in a forward direction of the airbag cushion when the airbag cushion is deployed, is installed in the airbag cushion.

3. The airbag device of claim 2, wherein the airbag cushion includes a front panel which is positioned in a direction toward a passenger when the airbag cushion is deployed, and a rear panel which is positioned to face the front panel and has a mounting portion of the airbag cushion that is mounted in a housing of the airbag cushion, and the internal tether has one end connected to the mounting portion of the airbag cushion, and the other end connected to the front panel.

4. The airbag device of claim 3, wherein the internal tether includes an upper internal tether and a lower internal tether that are spaced apart from each other in an upward and downward direction.

5. The airbag device of claim 4, wherein the external tether covers an outer surface of the airbag cushion that is positioned at a height between the upper internal tether and the lower internal tether when the airbag cushion is deployed.

6. The airbag device of claim 1, wherein the external tether is formed in a band shape having a predetermined vertical width.

7. The airbag device of claim 1, wherein the external tether is positioned in an intermediate region between an upper portion and a lower portion when an airbag is deployed.

8. The airbag device of claim 1, wherein a fracture portion, which is fractured when the airbag cushion is deployed to a predetermined size, is formed at the external tether.

9. The airbag device of claim 1, wherein the external tether has a sewed portion which is joined to a front panel of the airbag cushion and torn when an airbag is deployed.

10. The airbag device of claim 9, wherein the sewed portion includes first and second sewed portions that are spaced apart from a central portion of the front panel of the airbag cushion at a predetermined interval.

11. The airbag device of claim 10, wherein a portion of the external tether, which is positioned between the first and second sewed portions, is separated from the remaining portion of the external tether when the sewed portion is torn.

12. The airbag device of claim 10, wherein the sewed portion includes third and fourth sewed portions that are spaced apart from the first and second sewed portions so as to face each other toward a rear panel of the airbag cushion.

13. The airbag device of claim 12, wherein the third and fourth sewed portions are sewed to be joined to the front panel more strongly than the first and second sewed portions.

14. The airbag device of claim 1, wherein the external tether is disposed to cover from a portion where the airbag cushion is mounted on the airbag housing, to a portion that is spaced apart at least toward a front side of the airbag cushion at a predetermined distance from a reference line where the airbag cushion has a maximum diameter when the airbag cushion is deployed.
